(19) United States
(12) Patent Application Publication
(10) Pub. No.: US 2014/0239529 A1
(43) Pub. Date: Aug. 28, 2014

(54) System and Methods For Nano-Scale Manufacturing

(71) Applicant: Nanonex Corporation, Monmouth Junction, NJ (US)

(72) Inventors: Hua Tan, Princeton Junction, NJ (US); Lin Hu, Livingston, NJ (US); Yi Yao, Jersey City, NJ (US); Stephen Y. Chou, Princeton, NJ (US)

(73) Assignee: Nanonex Corporation, Monmouth Junction, NJ (US)

(21) Appl. No.: 14/042,618

(22) Filed: Sep. 30, 2013

Related U.S. Application Data
(60) Provisional application No. 61/707,129, filed on Sep. 28, 2012.

(51) Int. Cl. B29C 59/00

(52) U.S. Cl. CPC B29C 59/002
USPC 264/40.5; 264/571; 425/170

(57) ABSTRACT

A system and method for patterning a substrate includes a mold holding fixture for holding a mold with nanostructures and a substrate holding fixture for holding a substrate having a molding surface, a stage assembly has two or more independent axis movements for moving either the mold or the substrate therein, a contact force sensor sensing a contact force between the mold surface and the molding surface, a chamber for holding the mold and substrate and for the applying of a pressure inside that is higher or lower than atmospheric pressure, a pressure regulator and a manifold for changing the pressure inside the chamber, a door on the chamber housing provides for selectively allowing the substrate and the mold to pass there through, and means to divide the chamber into two fluidly separate sub-chambers.

### CROSS-REFERENCE TO RELATED APPLICATIONS

This application claims the benefit of U.S. Provisional Application No. 61/707,129, filed on Sep. 28, 2012, the disclosure of which is incorporated herein by reference.

### FIELD

This invention relates to system and methods for imprint lithography. It is particularly useful for fast mass production of substrates with replication of patterns from a mold having microscale or nanoscale features by imprint lithography and to achieve multilayer alignment accuracy better than 20 nm.

### BACKGROUND

Nanoimprint lithography, also often called imprint lithography, is capable of replicating patterns on a pre-made mold as small as several nanometers. The pre-made mold has extruded areas and recessed areas on its replication surface, which constitute patterns of various shapes and sizes. The mold was typically made by a patterning step using electron beam lithography (EBL) or mixing of EBL and optical lithography, and, a follow-up etching step using reactive ion etching (RIE) to create the patterns. Nanoimprint lithography starts from applying a volume of polymer onto a substrate by either spinning or dispensing. The polymer is either flowable in ambient temperature, or, from rigid to deformable or flowable by thermally heating. Then, the pre-made mold is positioned to contact with the substrate. After that, the mold is pressed against the substrate. If the polymer is in liquid in ambient temperature, pressing the mold against the substrate will force the surface extrusion areas on the mold replication surface to go into the layer of the polymer. If the polymer is rigid in ambient temperature, a thermally heating step is conducted prior to the contact, after the contact but before the pressing, or during the pressing to make the polymer deformable or flowable. Thus, pressing the mold against the mold is able to force the surface extrusion areas on the mold replication surface to go into the layer of the polymer. When the extruded areas completely go into the layer of the polymer, the polymer is transited from deformable or flowable into rigid by UV radiation, thermally heating or thermally cooling depending on types of the polymer. At last, the mold is released from the substrate while the layer of the polymer attaches to the substrate. To prevent the polymer from sticking to the mold, a very thin release coating may be deposited on the replication surface of the mold. Typical release coating included surface release surfactant and per-fluoro polymer deposited by CVD. After the substrate is separated from the mold, the extrusion areas on the mold surface are corresponding to the recessed areas in the polymer layer. Therefore, a reverse-tone replication of the patterns on the mold is formed onto the polymer film on the substrate. The polymer may be a thermo-plastic polymer or curable polymer. A thermo-plastic polymer transits from rigid to deformable or flowable when being heated above its glass transition temperature, and, vice versus when is cooled below its glass transition temperature. A curable polymer is deformable or flowable originally, and transit to rigid when being heating to curing temperature for thermo-set type or being cured under UV exposure for UV-curable type. When alignment is needed, the mold is aligned with the substrate through a set of matching align markers prior to the contact. Previously, electron beam lithography is very slow to write nanoscale patterns. It is unlikely to use it for mass production of nanoscale devices. Nanoimprint lithography is able to replicate whole area of patterned surface of the pre-made mold onto the substrate by one cycle of the process. It can dramatically increase the efficiency of patterning nanoscale features. Because the mold is repeatedly used for many cycles of imprinting, the high cost of using electron beam lithography to make the mold is averaged into these many imprints. Nanoimprint lithography delivers a practical method to produce nanoscale devices at low cost.

Since its invention in 1995 by Stephen Y. Chou (referring to U.S. Pat. No. 5,772,905), nanoimprint lithography has successfully demonstrated its capability of replicating a feature as small as 5 nm. Meanwhile, many research works were carried out on developing resists for imprinting, mold making techniques, mold release coating for clean separation, and apparatus to do imprinting. In overall, nanoimprint lithography has evolved into being a widely used technology for research laboratories, but not reached a stage ready to meet much higher requirements of industrial use. One of the important improvements needed by industrial use is imprint system and method with high throughput and overlay accuracy.

Fast nanoimprint apparatus is highly demanded by semiconductor and magnetic media industries to use this technology to manufacture nano-scale device products. Prior to the invention, the apparatus of nanoimprint lithography conducted aligning and contacting the mold with the substrate and pressing the mold against the substrate on two different sites within frame of the apparatus. Separating the mold from the substrate was often conducted on either one site of them or a third site. This basic design approach demanded to transfer the contacted mold/substrate set among these sites to finish a full cycle of operation. Thus, throughput of the apparatus, which is defined as time consumption to finish a cycle of imprinting, is severely degraded by time cost of transferring among these different sites. Furthermore, the internal transferring increases mechanical complexity of the apparatus and potentially introduces mechanical failure during operation. An apparatus capable of completing a full cycle of imprinting process on one site within its frame limit will potentially achieve much higher throughput and reliability.

Magnification control and nano-scale alignment are highly demanded by semiconductor industry for high quality nano-scale pattern transfers. On the other hand, the fluid pressure imprint, also known as Air Cushion Press (ACP), (referring to U.S. Pat. No. 6,482,742), has been widely accepted as the viable route for nanoscale manufacturing using nanoimprint. However, prior to the invention, the apparatus for fluid pressure imprint technology does not include method and apparatus for magnification control and nanoscale alignment. An apparatus and process capable of carrying out ACP while maintaining the magnification control and nanoscale alignment will potentially significantly improve the manufacturability of the nanoimprint for nanoscale patterning.

### SUMMARY

Various embodiments, in whole or in part, of the disclosed system and methods can provide for improved mass production of molds or substrates with micro-scale and nano-scale patterns using nanoimprint lithography.

According to one aspect, a method to pattern nanostructures on a substrate from a mold includes providing or having a mold having a mold surface with nanostructures and providing or having a substrate having a surface. A deformable material is deposited on the surface of the substrate. The method also includes positioning in a chamber the substrate with the deposited deformable material in a position facing the mold surface of the mold having the nanostructures and having a gap there between and applying a vacuum in the chamber including the gap defined between the positioned substrate and mold. The method also includes forming a contact between the surface of the substrate and the mold surface of the mold, holding the contact for a predetermined period of time, and separating the substrate and the mold with the deformable material remaining on the substrate and being patterned with nanostructures corresponding to the nanostructures of the mold surface.

According to another aspect, a system for patterning a substrate includes a mold holding fixture for holding a mold having a mold surface with nanostructures and a substrate holding fixture for holding a substrate having a molding surface. The system also includes a stage assembly that has two or more independent axis movements for moving either the mold or the substrate. Also included is a contact force sensor that is positioned for sensing a contact force between the mold surface and the molding surface. A chamber housing defines a chamber having at least a mold held by the mold holding fixture and the substrate held by the substrate holding fixture positionable therein. The chamber housing is configured for enabling the applying of a pressure inside the chamber that is higher and/or lower than atmospheric pressure. A pressure regulator and a manifold are each fluidly coupled to the chamber for changing the pressure inside the chamber. A gas reservoir of high pressure, a regulator and piping can be provided to allow the high pressure gas. A door on the chamber housing provides for selectively allowing the substrate and the mold to pass there through. A means is provided to divide the chamber into two fluidly separate sub-chambers with each sub-chamber being configured for a separate controlled sub-chamber environment including a separate pressure and/or vacuum, a separate gas content, and a separate gas flow rate into and out thereof.

According to yet another aspect, a method for aligning a mold and a substrate within a chamber for use in nanoimprinting includes providing a mold having a mold surface, forming a pedestal of predetermined height in a center of the mold; and placing nanostructures on a top surface of the formed pedestal. The method also includes placing alignment marks and gap sensing marks on both the top surface of the pedestal and the lower surface of the mold surface not containing the pedestal. The method also includes providing a substrate having a molding surface, depositing a deformable material on the surface of the substrate, and placing gap sensing marks and alignment marks on the substrate. The method further includes calibrating a gap measurement device having gap sensors using the predetermined pedestal height, detecting the gap sensing marks of the mold and the substrate to determine a gap distance between the mold surface and the molding surface, and detecting the alignment marks of the mold and the substrate to determine an alignment of the molding surface with the mold surface/The method also includes using the determined gap distance and the determined alignment to control the position of at least one of the mold and the substrate within the chamber for leveling the mold surface with the molding surface of the substrate and controlling the gap there between.

Further aspects of the present disclosure will be in part apparent and in part pointed out below. It should be understood that various aspects of the disclosure may be implemented individually or in combination with one another. It should also be understood that the detailed description and drawings, while indicating certain exemplary embodiments, are intended for purposes of illustration only and should not be construed as limiting the scope of the disclosure.

### BRIEF DESCRIPTION OF THE DRAWINGS

The features, nature and advantages of the various disclosed embodiments of the invention will be more clearly understood by consideration of the illustrative embodiments now to be described in detail in connection with the accompanying drawing. In the drawing:

FIG. 1 is a schematic drawing of the system illustrating one exemplary embodiment.

FIG. 2 is a schematic drawing illustrating the process chamber according to one exemplary embodiment.

FIG. 3a-3d illustrates operation process of the apparatus according to one exemplary embodiment.

FIG. 4 is a flow chart to show the system operation process according to one exemplary embodiment.

FIG. 5 is a flow chart to show steps of mold loading of the operation process according to one exemplary embodiment.

FIG. 6 is a flow chart to show steps of mold unloading of the operation process according to one exemplary embodiment.

FIG. 7 is a flow chart to show steps of substrates loading of the operation process according to one exemplary embodiment.

FIG. 8 is a flow chart to show steps of substrates unloading of the operation process according to one exemplary embodiment.

FIG. 9 is a flow chart to show detail steps of transferring molds from robot to the process chamber according to one exemplary embodiment.

FIG. 10 a flow chart to show detail steps of transferring molds from process chamber to robot according to one exemplary embodiment.

FIG. 11 a flow chart to show detail steps of transferring substrate from robot to process chamber according to one exemplary embodiment.

FIG. 12 a flow chart to show detail steps of transferring substrate from process chamber to robot according to one exemplary embodiment.

FIG. 13a-b a flow chart to show detail steps of process carried out inside the process chamber according to one exemplary embodiment.

FIG. 14 is a flow chart to show detail steps of contacting substrate with mold according to one exemplary embodiment.

FIG. 15 is a flow chart to show detail steps of separating substrate from mold according to one exemplary embodiment.

FIG. 16 is a flow chart to show detail steps of separating substrate from mold according to one exemplary embodiment.

FIG. 17 is a schematic drawing of the clamping mechanism for magnification control according to one exemplary embodiment.

FIG. 18a-b is a schematic drawing of the clamping mechanism for magnification control according to one exemplary embodiment.

FIG. 19 is a schematic drawing of the alignment apparatus of the system according to one exemplary embodiment.

FIG. 20 is a schematic drawing of the alignment and gap sensing mark placement on the mold and substrate according to one exemplary embodiment.

FIG. 21a-b illustrates design of system where front and back side of substrate surfaces may be patterned by two molds simultaneously according to one exemplary embodiment.

FIG. 22 is a block diagram of a computer system that may be used to implement one or more embodiments of the methods and system.

It is to be understood that these drawings are for purposes of illustrating the various embodiments of the invention and are not to scale.

### DETAILED DESCRIPTION

The following description is merely exemplary in nature and is not intended to limit the present disclosure or the disclosure's applications or uses. Before referring to the exemplary embodiments shown in the drawings, various embodiments will be described.

In some embodiments, the system has a chamber with transparent sections on its top wall and side wall. A hollow mold holder is fixed to the top inner surface of the chamber and positioned underneath the transparent top section. By changing the type of mold holders used in the system, molds of different materials or different sizes and thicknesses may be fixed to the mold holder and carry out imprint. More specifically, transparent, semi-transparent or opaque molds (all referring to visible wavelength) may be used in the system for nanoimprinting. An enclosed volume referring to mold mini-chamber is formed between the mold/holder and top wall of the chamber. Inside chamber, a stage assembly, leveling apparatus, and force sensing apparatus are installed. A chuck to vacuum hold a substrate is mounted on top of the stage assembly. At beginning of the imprinting, the substrate with a layer of resist is positioned underneath the mold at a predetermined gap between them. Then, the substrate is moved up to contact with the mold either under vacuum, under atmosphere or under pressure from a mixture of different gases. The substrate and mold may be pressed further by introducing higher pressure inside the chamber. After consolidating the resist, the substrate is separated from the mold by motions enabled by stage movements, or deforming the mold enabled by differential pressure between the mold mini-chamber and the bulk volume of the chamber, or mixing of both.

On the side wall of the chamber, there is also a gate which allows the mold and substrates of various sizes to be passed through. Upon activation, the gas driven gate will move up first and then move horizontally to seal against the wall. Additional air driven cylinders will be used to further push against the door to make sure the chamber can take high pressure as well as high vacuum.

A multi-axis robot is used to transfer the imprint molds and substrates to the chamber. Different end effectors may be mounted on the same robot to handle molds and substrates of different form factors. Positions and orientations of molds and substrates may be adjusted at different stations in the system. Before imprint, the molds are adjusted with the patterned side facing down, while the substrates are adjusted with the patterned side facing up. After imprint, the molds are adjusted with the patterned side facing up before placing back into the mold cassette.

In one embodiment, method to pattern nanostructures on a substrate from a mold includes providing or having a mold with a mold surface with nanostructures and a substrate having a surface. The mold can be made of any suitable material including but not limited to a quartz, a glass, a silicon, a Ni, a plastic, and a semiconductor. Further, the thickness of the mold can be of any thickness but in some embodiments has a mold thickness of between about 0.1 mm to about 25 mm.

The method also includes depositing a deformable material on the surface of the substrate and then positioning in a chamber the substrate with the deposited deformable material in a position facing the mold surface of the mold having the nanostructures and having a gap there between. In some embodiments, the gap between the mold and substrate has a range of about 100 nm to about 3 mm.

The process next includes applying a vacuum in the chamber including the gap defined between the positioned substrate and mold and then forming a contact between the surface of the substrate and the mold surface of the mold. The process also includes holding the contact for a predetermined period of time and separating the substrate and the mold with the deformable material remaining on the substrate and being patterned with nanostructures corresponding to the nanostructures of the mold surface. The method can also include forming the contact by moving one or both of the substrate and the mold towards the other until the contact occurs. In some embodiments, the contact is held by applying at a predetermined pressure one or more gases in an area of the chamber that is proximate to the mold and the substrate and removing the applied gases to return the pressure to atmospheric pressure.

In some embodiments, forming the contact includes determining an initial distance of the gap between the mold surface and the substrate surface, adjusting at least one of the substrate and the mold to establish the predetermined value of the distance of the gap and then pressing the mold and the substrate towards to each other using a predetermined and/or controlled pressure. This can include pressing using any type of pressure but in one embodiment includes fluid pressure applied at a pressure of between about −14.6 psi and about 500 psi. This can include fluid pressure supplied by a non-reactive gas from a group of gases selected from the group consisting of nitrogen, air, argon, and helium, by way of example and not intending to be limited thereto. This can include applying of vacuum includes removing the gas molecules from the spacing between the mold and the substrate to a pressure of between about 0.1 to about 25 ton.

In some embodiments, forming contact is controlled to deform a center portion of the mold and the substrate more than other portions thereof so that the contact between the mold surface and the substrate surface if first made in a center of the mold and in a center of the substrate, and wherein the forming continues until contact continues outwards from the initial center contact to throughout the area of the mold surface.

In some embodiments, forming contact includes securing at least one of the substrate and the mold, determining an initial distance of the gap between the mold surface and the substrate surface, then adjusting at least one of the substrate and the mold to establish the predetermined value of the distance of the gap. This can also include after the predetermined gap distance is adjusted, applying a controllable force to move the mold and/or substrate into contact; and then after contact is formed by the application of the controllable force, releasing the secured at least one of substrate and the mold so at least one of the contacting mold surface and substrate surface continue to contact in an unrestricted manner. The applying of the controllable force can include applying upward uniform fluid pressure on the substrate so the opposing sides of the substrate and the mold freely contact each other.

In some embodiments, forming contact includes determining an initial distance of the gap between the mold surface and the substrate surface, and adjusting at least one of the substrate and the mold to establish the predetermined value of the distance of the gap. This can also include deforming the mold to form the contact between the substrate surface and the mold surface and then restoring the mold to its original shape while the substrate retains the contact with the mold. This deforming of the mold can includes controlling a differential pressure between two sides of the mold for said deforming.

In some embodiments, the process of separating can include retaining at least a portion of a non-contact side of the mold that is opposing the mold surface, retaining at least a portion of a non-contact side of the substrate that is opposing the surface having the deformable material deposited thereon and then moving the substrate away from the mold in a series of controlled motions until the substrate is released from the mold. The controlled motion can be controlled for movement in one or more of 6 axis x, y, z, theta, tip, tilt and can be controlled by or responsive to or as a factor of one or more control factors selected from the group consisting of distance, motion, force speed, acceleration, deceleration, and time.

In some embodiments, separating can include retaining at least a portion of a non-contact side of the mold that is opposing the mold surface and retaining at least a portion of a non-contact side of the substrate that is opposing the surface having the deformable material deposited thereon. This can also include deforming the mold until initially a peripheral region of the substrate is first released from the mold, said deforming being effected by a differential pressure between two opposing sides of the mold and then restoring the mold to its original shape until the substrate is released from the mold.

In other embodiments, a system for patterning a substrate includes a mold holding fixture for holding a mold having a mold surface with nanostructures and a substrate holding fixture for holding a substrate having a molding surface. The mold holding fixture can be configured to hold molds having different shapes and/or form factors inside said chamber.

The system also includes a stage assembly that has two or more independent axis movements for moving either the mold or the substrate. Also included is a contact force sensor that is positioned for sensing a contact force between the mold surface and the molding surface. A chamber housing defines a chamber having at least a mold held by the mold holding fixture and the substrate held by the substrate holding fixture positionable therein. The chamber housing is configured for enabling the applying of a pressure inside the chamber that is higher and/or lower than atmospheric pressure. A pressure regulator and a manifold are each fluidly coupled to the chamber for changing the pressure inside the chamber. A gas reservoir of high pressure, a regulator and piping can be provided to allow the high pressure gas. A door on the chamber housing provides for selectively allowing the substrate and the mold to pass there through. A means is provided to divide the chamber into two fluidly separate sub-chambers with each sub-chamber being configured for a separate controlled sub-chamber environment including a separate pressure and/or vacuum, a separate gas content, and a separate gas flow rate into and out thereof.

The mold holding fixture can be configured for holding only a periphery of the mold. It can also be configured with a hollow to expose a central area of the mold for accessing from the side of the molding surface and the opposing side. The mold holding fixture can be attached to inner surface of the chamber and have substantially flat surfaces for uniformly holding the mold with substantially distributed equalized pressure for minimizing deformation of the held mold. In some embodiments, mold holding fixture can be configured for holding a periphery of the mold and having substantially flat surfaces for uniformly holding the mold with substantially distributed equalized pressure for minimizing deformation of the held mold.

In some embodiments, a robot is provided that has end effectors and is controlled by a computer with computer executable instructions, each or the combination thereof being configured for placement of a substrate in a first position inside the chamber, and placement of a mold in a second position inside the chamber cavity.

The robot can be configured for placing one or more molds and/or substrates, each of which has a different size and/or composed of a different material, into and out of the chamber. The robot can be configured for changing the orientation of the mold or the substrate by flipping it 180 degrees. The robot can include at least one arm coupled to a driving means and wherein the at least one arm includes two end effectors for handling the mold and the substrate.

A loader can be positioned proximate to the robot and the chamber housing, each loader configured for housing a plurality of cassettes, each cassette holding one or more molds or substrates. The end effectors can be configured for removing a mold and/or a substrate from one of the cassettes for placement within the chamber and return thereto.

In some embodiments, a vibration controlled table, wherein the chamber housing is placed thereon.

The chamber housing can include one or more windows to the chamber configured for allowing light of one or more wavelengths to pass through the window while maintaining the applied pressure inside the chamber. At least one of the chamber windows can be coated with multiple layer thin films for reducing light reflections on the window surfaces.

In some embodiments, one or more gap measurement devices or systems is configured to determine a gap distance between the mold surface of the mold and the molding surface of the substrate while each is in the chamber. In such embodiments, a gap distance control means can provide for adjusting a position of at least one of the mold and the substrate to obtain a predetermined distance. The gap measurement devices can be of any suitable type including, by way of example, an optical detection system configured for determining a spatial relationship between the mold and the substrate. The gap measurement device can includes one or more sensor such as a laser sensors, and optical sensors, an optical microscopes, and a radiofrequency transceiver sensor, by way of example and not intended to be limited thereto.

The method can also include monitoring the gap sensing marks of the mold and the substrate to determine a gap distance between the mold surface and the molding surface and wherein the microscopes and optical sensors use a working wavelength from visible to IR (400 nm-2000 nm).

The gap measurement device can includes one or more optical microscopes and the mold and the substrate can include alignment marks. In such embodiments, the optical microscopes can be configured and/or positioned for observing each of the mold and the substrate alignment marks when the mold and the substrate are positioned within the chamber under an applied pressure.

In some embodiments as described herein, the system can include means to deform the mold transversely toward or away from the substrate while each are within the chamber. This means to deform the substrate can be to deform the substrate towards or away from the mold using multiple motions capable of six degree of freedom while each are within the chamber.

In some embodiments, means to position the mold and the substrate relative to each other before the mold and the substrate are placed within the chamber is provided.

As will be described, in some embodiments, one or more UV lamps positioned either outside or inside of the chamber for exposing UV radiation onto the substrate.

The mold holding fixture can include one or more mechanical stops and the system can include one or more mechanical clamps coupled to the mold and one or more drivers such as piezo drivers that are coupled to the mechanical clamps. In such an example, the drivers and the mechanical clamps can be configured to apply a pressure against a mold held by the clamps and push the mold against mechanical stops and controllably deforming the mold along at least one of the X and Y directions.

In some embodiments, he mold holding fixture and the substrate holding fixture are each configured within the chamber for holding the mold and substrate respectively in any orientation therein, and wherein each are configured for holding using a force selected from the group consisting of a vacuum, a mechanical force, and an electrostatic force.

In some embodiments, two molds and one substrate may be loaded inside chamber, said substrate is placed between said molds, and the deformable materials on both front and back surfaces of the substrate may be pressed by the said two molds.

In another embodiment, a method for aligning a mold and a substrate within a chamber for use in nanoimprinting includes providing a mold having a mold surface, forming a pedestal of predetermined height in a center of the mold. In some embodiments, the height of the pedestal has a range of about 0.1 to about 100 microns. The method can include placing nanostructures on a top surface of the formed pedestal. The method also includes placing alignment marks and gap sensing marks on both the top surface of the pedestal and the lower surface of the mold surface not containing the pedestal. The method also includes providing a substrate having a molding surface, depositing a deformable material on the surface of the substrate, and placing gap sensing marks and alignment marks on the substrate. The method further includes calibrating a gap measurement device having gap sensors using the predetermined pedestal height, detecting the gap sensing marks of the mold and the substrate to determine a gap distance between the mold surface and the molding surface, and detecting the alignment marks of the mold and the substrate to determine an alignment of the molding surface with the mold surface/ The method also includes using the determined gap distance and the determined alignment to control the position of at least one of the mold and the substrate within the chamber for leveling the mold surface with the molding surface of the substrate and controlling the gap there between.

The method can include that the determination of the gas is calibrated by measuring the gap between the mold pedestal surface and the substrate surface and the gap between the lower mold substrate and the substrate, and comparing the difference of the two measured gaps to the predetermined pedestal height to calibrate the gap readings linearly.

The descriptions assume that UV curable imprint is conducted if it is not clearly identified and UV curable imprint is used as example. However, the disclosed system and method are not limited to UV curable imprint and can also be applicable for thermo-plastic imprint. After reviewing the present disclosure, one of ordinary skilled in the art who is familiar with nanoimprint technology should be able to revise the disclosed exemplary embodiments described in this disclosure to implement the concepts herein for all types of imprinting without undue experimentation.

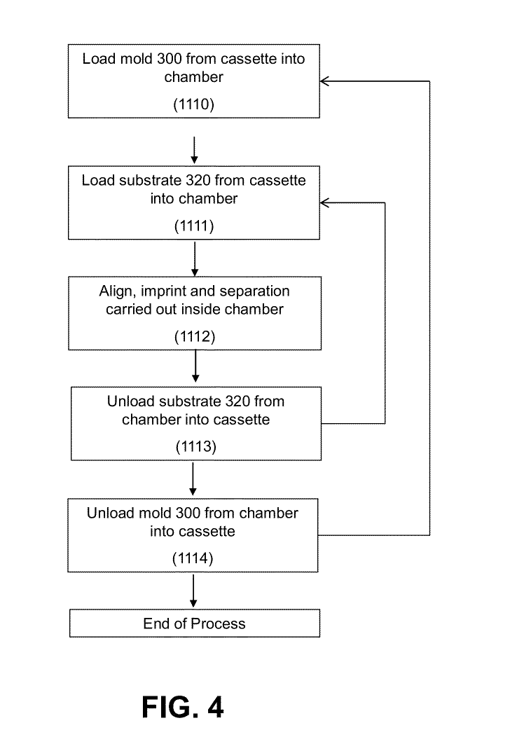

Referring now to the figures, in one embodiment, the overall process of the system is illustrated in FIG. 4. Referring to step 1110 and 1111, mold 300 is first be loaded from a cassette into a chamber, then substrate 320 is loaded from a cassette 504 into the chamber 140. The alignment, imprint and separation are carried out inside the chamber 140 (step 1112). Then the substrate 320 is unloaded from the chamber 140 back into the cassette 504 (step 1113). Now that one imprint is finished, the system enables the user to select whether to load a new substrate 320, to load a new mold 300, or to finish up the process. If the process is finished, the system will start to unload the mold 300 (step 1114). If the user would like to load a new mold 300, the system will unload the current mold 300 (step 1114), then go back to step 1110. If the user would like to load a new substrate 320, then the system goes back to step 1111.

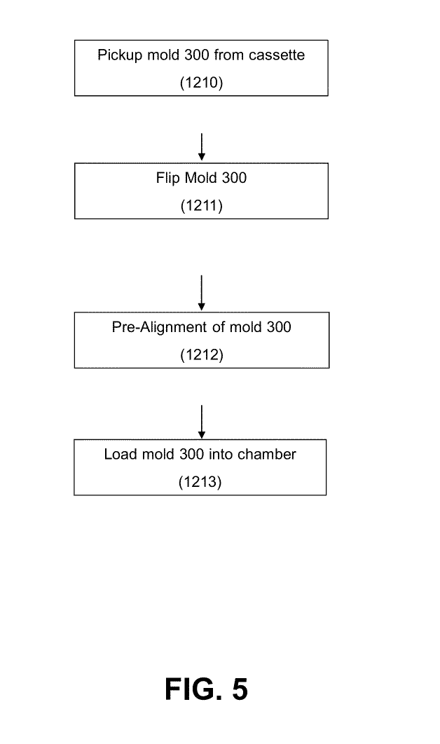

Sample loading and unloading processes of the system are illustrated in the series of drawings of FIGS. 5-8, by way of some embodiments.

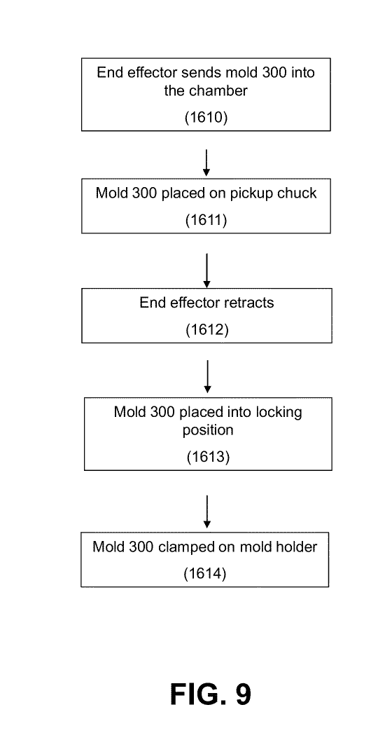

The step 1110 of loading mold 300 from cassette 504 to chamber 140 is further illustrated in FIG. 5, by way of one embodiment. A robot 502 is controlled to pick up mold 300 from the cassette 504 (step 1210), then flip the mold 300 so that the pattern surface of the mold 300 is facing down (step 1211). After that, the mold 300 is placed inside a pre-aligner where its position in the X, Y, and Z plane is determined (step 1212). The system will use this determined position to control the robot to send the mold 300 to a predetermined position inside chamber 140. Finally, the robot 502 is controlled to continue to load the mold 300 into the chamber 140 (step 1213). Step 1213 of loading mold 300 into the chamber 140 is further illustrated in FIG. 9.

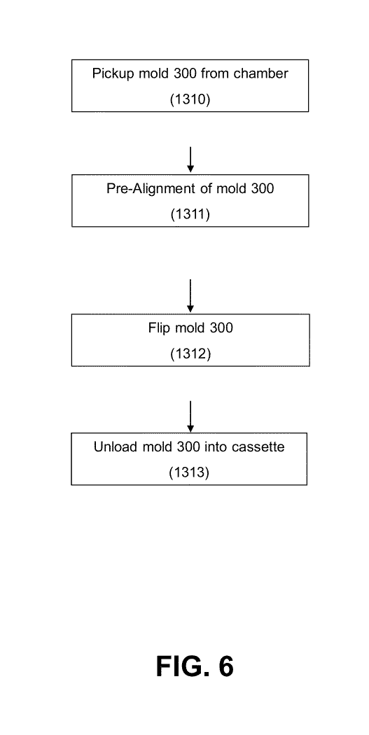

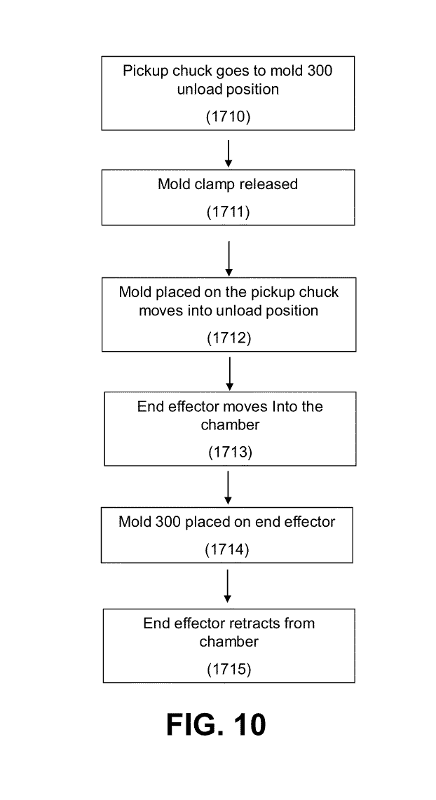

The step 1114 of unloading mold 300 is further illustrated in FIG. 6. The robot 502 is controlled to pick up mold 300 from the chamber 140 (step 1310), then align the mold 300 so that its position in the X, Y, and Z plane is determined (step 1311). The system uses this determined position to control the robot 502 to move the mold to a predetermined position in the cassette 504. After that, the mold 300 is flipped so that its nanostructured patterned surface is facing upward (step 1312). Finally, the robot 502 is controlled to unload the mold 300 from the chamber into the cassette 504 (step 1313). Step 1310 of unloading mold 300 from the chamber 140 is further illustrated in FIG. 10.

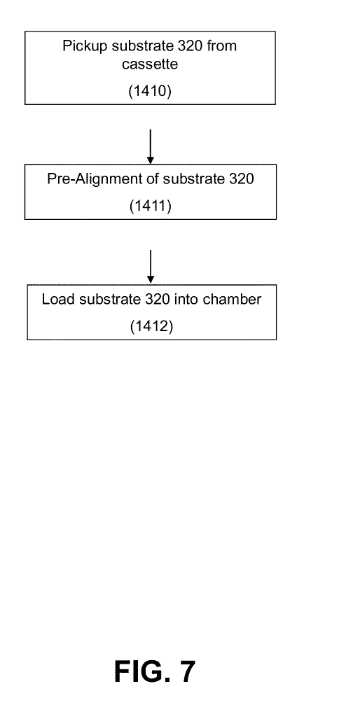

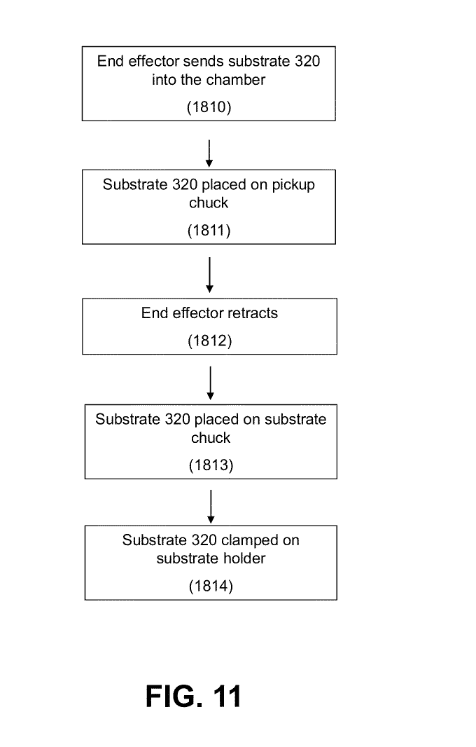

The step 1111 of loading substrate 320 is further illustrated in FIG. 7. The robot 502 is controlled to pick up substrate 320 from a cassette 504 (step 1410), then pre-align the substrate 320 it so that its position in the X, Y, and Z plane is determined (step 1411). The system uses this determined position to control the robot 502 to move the substrate 320 to a predetermined position inside chamber 140. Finally the substrate 320 is placed inside chamber 140 (step 1412). Step 1412 of loading substrate 320 into the chamber 140 is further illustrated in FIG. 11.

Pre-alignment of molds 300 and/or substrates 320 can be carried out using one or more sensor 507 including, but not limited to laser sensors, LED sensors, mechanical sensing structures, and optical sensors such as a microscopes or optical detector or imaging device. By way of example as to the substrate 320 (being understood that the same can apply to the mold 300), mechanical structures such as four (4) identical and symmetric orientated slopes may be used to center the substrate 320 by gravity force. Mechanical stops can be utilized to hold the substrate 320 therefore providing for the determining of their position in the Z axis direction. The edges of the substrate 320 can also be detected by the sensors 507. One or more Microscopes 405, 406 can also be used to capture the images for determining the position of the substrate 320 and/or mold 300 in their respective X-Y planes. Furthermore, in some embodiments a theta stage can also be included in the center for rotation in the X-Y plane. In other embodiments, a substrate 320 or mold 300 can be pre-aligned while it is still on an end effector 501 of the robot 502. In such embodiments, since the Z position is already determined by the controlling robot 502, only the X, Y position needs to be determined which is possible through movement of the robot through one or more sensors 507 to enable the sensor(s) 507 to detect the edges of the substrate 320 and/or mold 300.

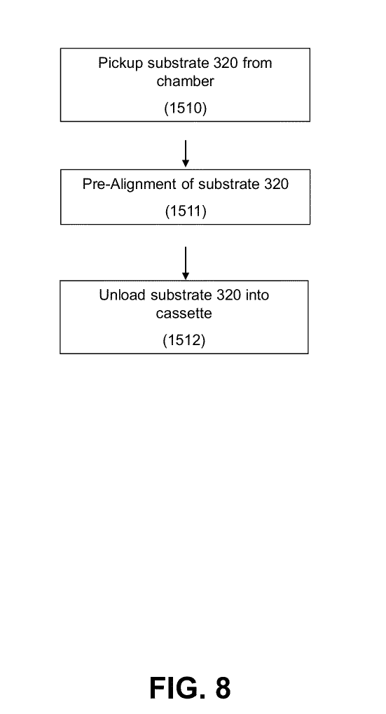

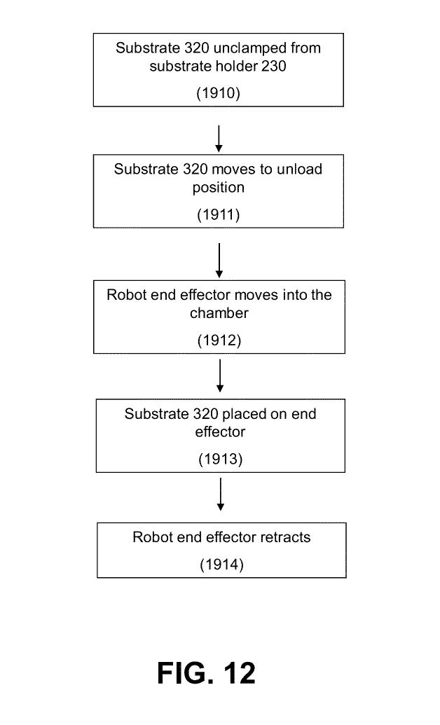

The step 1113 of unloading substrate 320 is further illustrated in FIG. 8. The robot 502 is controlled to pick substrate 320 from the chamber 140 (step 1510), and then align the substrate 320 to enable the determined of its position in the X, Y, and Z plane (step 1511). Finally the substrate 320 is placed back into the cassette 504 (step 1512). Step 1510 of unloading substrate 320 from the chamber 140 is further illustrated in FIG. 12.

The step 1213 of loading mold 300 is further illustrated in FIG. 9. The robot 502 is configured to use end effector 501 to send mold 300 into the chamber 140 (step 1610), place it on a pickup chuck (step 1611), then the end effector 501 retracts (step 1612), meanwhile the mold 300 inside chamber 140 is placed into a locking position by stage assembly 210 (step 1613). Finally the mold 300 can be clamped to the mold holder 200 (step 1614).

The step 1310 of unloading mold 300 from chamber 140 is further illustrated in FIG. 10. The pickup chuck will move to the mold 300 unload position (step 1710), then the mold 300 will be unclamped (step 1711), and placed on the pickup chuck to move into unload position (step 1712). End effector 501 will move into the chamber 140 (step 1713), pick up the mold 300 (step 1714), and retract from the chamber 140 with the mold 300 (step 1715).

The step 1412 of loading substrate 320 into the chamber 140 is further illustrated in FIG. 11. End effector 501 will send substrate 320 into the chamber 140 (step 1810), place it on pickup chuck (step 1811), then retract (step 1812). Substrate 320 will then be placed on the substrate chuck 230 (step 1813), and clamped on the chuck 320 (step 1814).

The step 1510 of picking up substrate 320 from chamber 140 is further illustrated in FIG. 12. First substrate 320 will be unclamped from substrate holder 230 (step 1910), and moved to unload position (step 1911). Robot end effector 501 will move into the chamber 140 (step 1912). After substrate 320 is placed on the end effector 501 (step 1913), the end effector 501 will retract (step 1914).

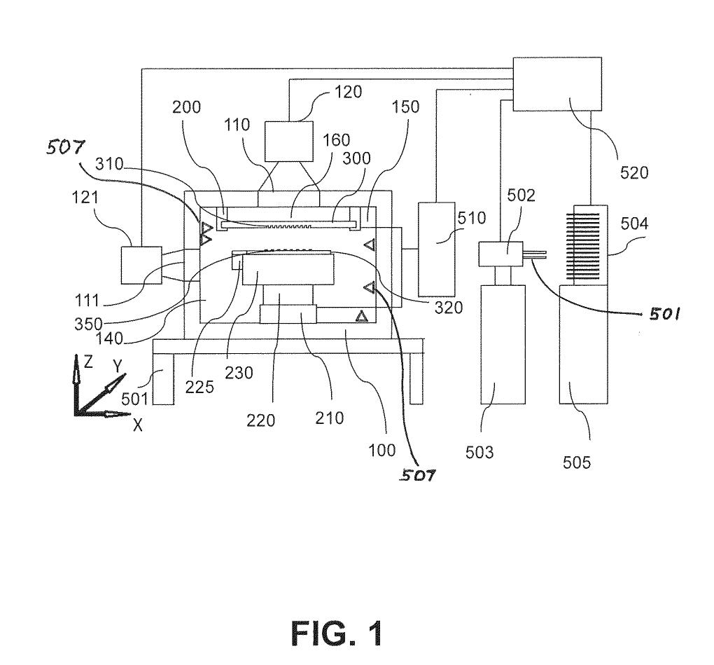

In accordance with one exemplary embodiment, referring to FIG. 1, the system has a chamber housing 100 that defines chamber 160 in which a vacuum or pressure can be created. The chamber housing 100 is placed on a vibration controlled table 501. A multi-axis robot 502 with two (2) end effectors 501 can be used to pick up molds 300 and substrates 320 from cassettes 504. The cassettes 504 are seated on front loaders 505 while the robot 502 is seated on mounting frame 503. The end effectors 501 may have different sizes to hold mold 300 or substrate 320 of different materials or different sizes. The complete system can be controlled by control system 520 such as a personal computer or the like, such as the specialized computer as describe below. The control system 520 is further connected to sub-control unit 510, which includes PLC (Programmable Logic Controller), stage controllers, and pneumatic controls and lines. The pneumatic lines further includes at least a vacuum pump, a gas reservoir of high pressure (larger than or equal the maximum pressure needed in the chamber), regulators and valves, sensors and switches, gas and vacuum lines, flow meters, manifolds, and air cylinders. To improve the system performance, multiple vacuum pumps and vacuum reservoir may be used.

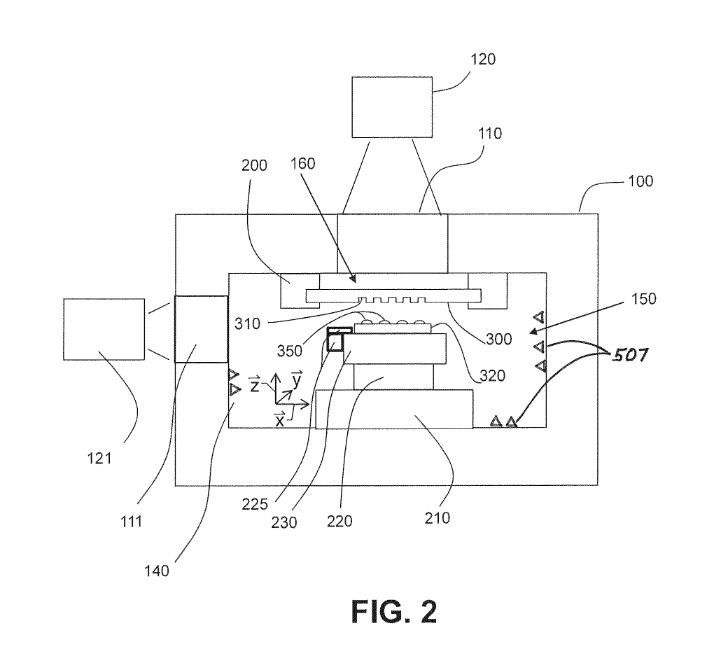

Referring to FIG. 2, the top wall of the chamber 100 has a light passing through section 110 while the side wall of the chamber housing 100 has light passing through sections 111. Section 110 could be an optical transparent window made of quartz or glass. The section is able to hold vacuum seal and built-up pressure inside the chamber during operation. Section 110 allows a UV light passing through to provide UV curing exposure for UV curable imprint, a visible light passing into the chamber housing 100, e.g., inside chamber 140, and an Infrared light passing through to view inside of the chamber 140 using infrared images. For such purpose, a UV radiation source 120 is mounted outside chamber housing 100 and above section 110 for radiating there through. An alternative mounting for UV source 120 is to mount the source 120 elsewhere and use a plurality of mirrors to deflect UV light to pass through section 110. In case of doing thermal imprint, the UV radiation source is replaced by heating lamp. Secondarily, section 110 allows viewing inside of the chamber 140 for alignment using microscopes 405, 406, process monitoring using cameras or laser sensors or optical sensors, or a combination of some of them. The side wall of the chamber housing 100 of chamber 140 has light passing through sections 111. Section 111 could be an optical transparent window made of quartz or glass. The sections 110 and 111 are able to hold vacuum seal and built-up pressure inside the chamber 140 during operation. Section 111 allows UV lights passing through to provide UV curing exposure for UV curable imprint, visible lights passing into the chamber 140, and Infrared lights passing into the chamber 140 using infrared images. For such purpose, UV radiation sources 121 mounted outside chamber housing 100 can be adjacent to or within operating position of section 111. An alternative mounting for UV source 121 is to mount the sources elsewhere and use a plurality of mirrors to deflect UV light to pass through section 111. In case of doing thermal imprint, the UV radiation source 121 can be replaced by a heating lamp. Secondarily, section 111 enables the viewing of the inside of the chamber 140 from outside or by a sensor or optical receiver for alignment using microscopes 405, 406, process monitoring using other sensors 507 can include cameras or laser sensors or optical sensors, by ways of example, or a combination of such sensors 507.

A mold 300 for imprinting is held against a mold holder 200 by using vacuum, electrostatic or mechanical clamp. The mold holder 200 is hollow to permit a central patterned region 310 of mold 300 to be freely accessible from underneath side, top side or both sides. The surfaces in contact with the mold 300 on the mold holder 200 are typically uniform, and the mold holder 200 can hold the mold 300 with minimum deformation of the mold 300. During operation, the mold holder 200 is loaded into the chamber 140 and firmly attached to inner surface of top wall of the chamber 140, typically by mechanical means. The mold holder 200 is positioned to have patterned region 310 exposable through section 110, or section 111 or both, and accessible from underneath. By using mold holder 200 of different sizes, mold 300 of different sizes or materials can be used.

An enclosed mold mini-chamber 160 is formed by body of mold holder 200, mold 300 and top inner surface of the chamber wall. Being contrast with mold mini-chamber 160, the rest bulky inner volume of the chamber 140 is generally referred herein as the chamber volume 150, however, this is also generally referred herein as the chamber 140. The chamber 140 is connected with pneumatic lines (not shown) that independently control pumping or pressurizing of mold min-chamber 160 and chamber volume 150. The control and pneumatic lines provide the gas flow rate, gas type, and gas pressure to be finely controlled. Therefore, both of mold mini-chamber 160 and chamber volume 150 of the chamber 140 can be pumped to a vacuum and/or pressurized and a differential pressure between the mini-chamber 160 and the chamber volume 150 can be selectively established. Depending on the process, one or both of chamber volume 150 and mini-chamber 160 can be pumped or otherwise reduced down to a range of about 0.1 ton to about 25 torr. Further, one or both of chamber volume and mini-chamber 160 can be pressurized from about −14.6 to about 500 psi. Non-reactive gas from a group of nitrogen, air, argon, helium, by way of examples and not intending to be limited thereto, or any mixture thereof, may be used to supply the fluid pressure needed in the process.

Inside the chamber, a stage assembly 210 is mounted onto the bottom wall of the chamber 140 as defined by chamber housing 100. The stage assembly 210 can include a Z motion control in order to accomplish desired process of the apparatus. The stage assembly 210 can also include X-Y-θ-tip-tilt motion controls in order to align the fiducial marks on the substrate 320 to the marks on the mold 300. The 3 axis θ-tip-tilt motion may provide adjustment to make to be patterned surface of substrate 320 parallel to the patterned surface of the mold 300. A chuck 230 with vacuum grooves on its top surface can be mounted on a force sensing apparatus 220 which in turn is mounted on the stage assembly 210. A substrate 300 for imprinting is held on chuck 230 by vacuum pumping through the vacuum grooves.

Additionally, an apparatus 225 can be used to clamp the substrate along the plane X-Y by mechanical means. The surface of the chuck 230 is designed and special polished in order to hold the substrates 320 with minimum deformation. The stage assembly 210 is either mechanically installed or capable of moving the substrate 320 within its X-Y travel ranges to superimpose the center of the substrate 320 with the center of patterned region 310 in X-Y plane. The substrate 320 may have a moldable material 350 applied on its side surface facing the mold 300 before imprint begins. The moldable material 350 could be a continuous film layer of imprinting resist spun on or a plurality of droplets 350 of imprinting resist dispensed on (reference number 350 is used to refer droplets of the moldable material by way of example herein). When the moldable material 350 is in form of a plurality of droplets before imprinting, the distribution of the droplets 350 could be a uniform matrix of equal spacing among adjacent droplets 350 along one direction or multi directions, or an arbitrary matrix optimized for merging each to achieve desired imprinted patterns. In addition to these general demands for imprinting, in some embodiments, the special distribution of droplets is preferred to deliver a uniform and continuous contacting interface between the mold 300 and the substrate 320 during the imprint process of the apparatus.

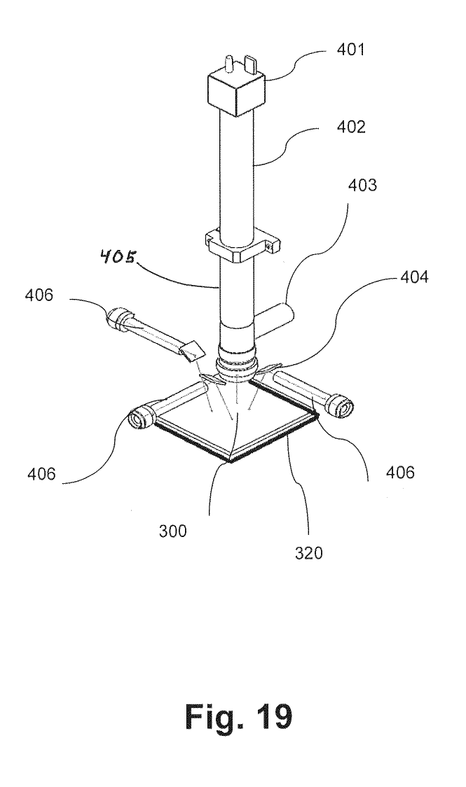

Referring to FIG. 19, alignment apparatus in the system has four microscopes 406 and 405. Three of them are titled microscopes 406 while one of them is vertical. The vertical microscope 405 includes imaging device 401, lens tube 402, illumination mount 403 and objective lens (not shown). Typically, in some embodiments, the vertical microscope 405 has a higher NA than the other three titled microscopes 406, and is used for coarse alignment of substrates 320 to the mold 300. The titled microscopes 406 can use moiré alignment marks on both the mold 300 and the substrate 320 to read the miss-alignment between them at different locations. Minors 404 are used to reflect the light source and image. Depending on the type of mold 300 to be used, the wavelength of illumination lights for the microscopes 406, 405 can be either in visible (400 nm-800 nm) or IR (800 nm-2000 nm) range. To prevent illumination lights from exposing the imprint resists, UV block filters are used in the illumination paths. Alternatively, two vertical microscopes 405 can be used for both the coarse and fine alignment. Again, the wavelength of illumination lights can be either in visible (400 nm-800 nm) or IR (800 nm-2000 nm) range. UV block filters (not shown) can be used in the illumination paths. The microscopes 406, 405 are positioned for optical images through the opening section 110 of the chamber body 100. By coating the window of opening 110 with multiple layer thin films for working wavelengths of microscopes 405, 406, the light reflection at the surfaces may be significantly reduced, therefore increase the image quality of the microscopes 405, 406, enabling a more accuracy and fast alignment.

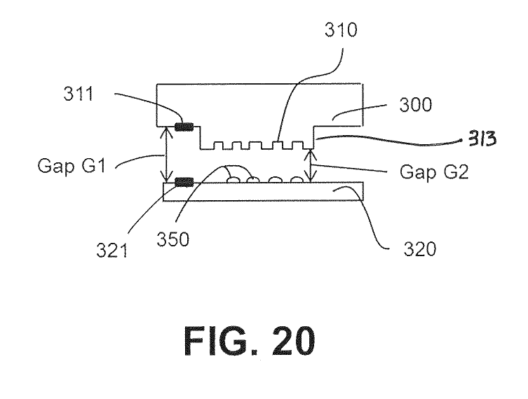

Alignment marks may be specially designed to work with the microscopes 405, 406 to make the alignment process quicker and more accurate. Referring to FIG. 20, in one arrangement of the design, a center pedestal area 313 is created on the mold 300. The height of the pedestal 313 (gap difference between Gap G1 and Gap G2) is tightly controlled during fabrication of the mold 300. Alignment and gap sensing marks 311 on the mold 300, and alignment and gap sensing marks 321 on the substrate 320 may be placed outside of the imprint area 313. There are many advantages using this method. First, the alignment marks 311, 321 are outside of imprint patterning field therefore they can be used throughout the imprint process, making adjustment of alignment during substrate 320 and mold 300 contacting process possible. Second, the gap sensing marks 311, 321 can be used to measure the distance between the mold 300 and substrate 320 even when they are very close. Optical sensors used for measuring the gap can have a reduced accuracy when the gap is less than 30 um. When the mold 300 and the substrate 320 are in contact, while gap G2 may be less than about 30 um, gap G1 may still be used to obtain good measurement accuracy. Third, the alignment and gap sensing marks 311, 321 can be outside of the area of imprinting such as pedestal 313 where there are resist droplets 350, making recognition of marks and gap reading reliable and accurate.

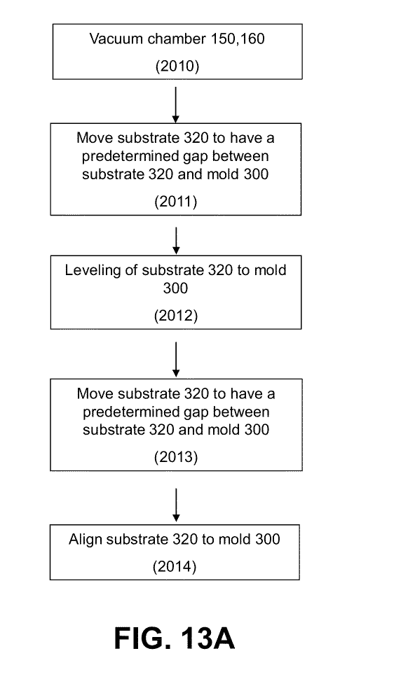

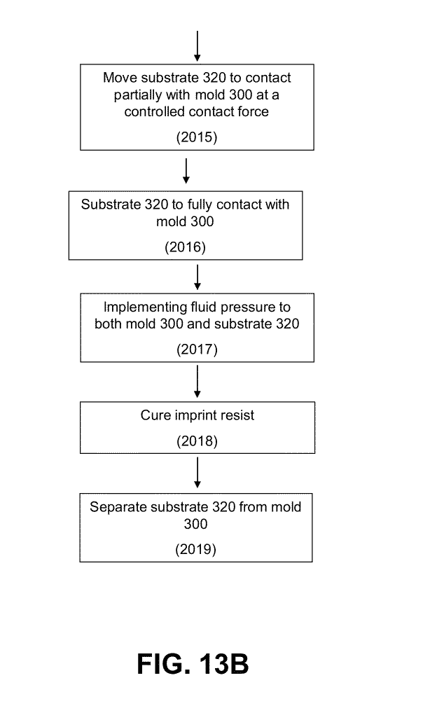

Referring to FIG. 4, the step 1112 of alignment, imprint, and separation process carried out inside chamber 140 is further illustrated in FIG. 13a-b. In FIG. 13a-b, the two chambers 150 and 160 within chamber 140 can first be vacuumed (step 2010), then substrate 320 will move until a gap G2 between substrate 320 and mold 300 is obtained (step 2011), then the substrate 320 can be adjusted to be in parallel with the mold 300 (step 2012), the gap G2 between substrate 320 and mold 300 will then be further adjusted (step 2013), and then the substrate will be aligned with the mold (step 2014), and moved up to start to contact with mold at a controlled force (step 2015). Then the substrate 320 and mold 300 will make a full contact (step 2016). Fluid pressure or other pressure such as mechanical or any suitable pressure can be applied (step 2017). After that, deformable material 350 is cured (step 2018) and substrate 320 is separated from the mold 300 (step 2019).

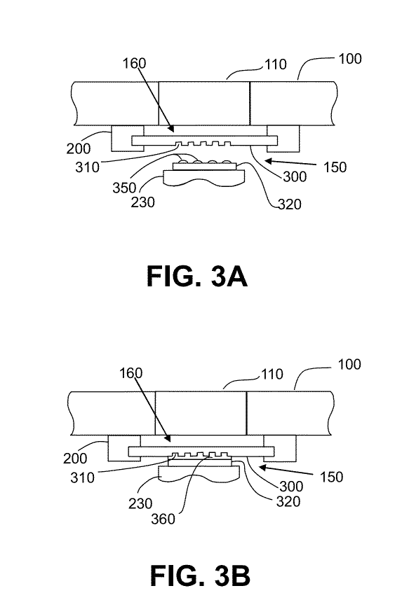

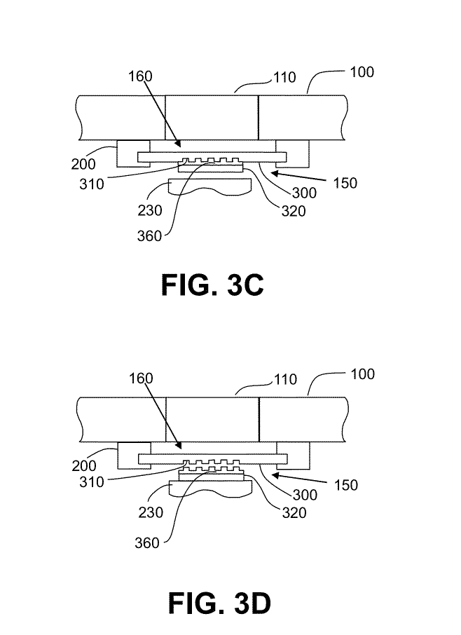

Referring to FIG. 3a, mold holder 200 with mold 300 installed is loaded into chamber 100 and firmly attached to top plate of the chamber wall by cylinders or similar mechanical means. Substrate 320 with moldable material 350 on its top surface is held against chuck 230 by pumping through the vacuum grooves and positioned beneath the opening of mold holder 200. As shown in FIG. 13a, step 2011, at beginning of the imprint process of the apparatus, substrate 320 is positioned to a starting position which normally has a 1-2 millimeter gap between the substrate 320 and the mold 300. Gap measuring sensors 507 can be used to detect mold 300 and substrate 320 gap G2 at one or more different locations, such as three (3) different locations by way of one exemplary embodiment). Then the substrate 320 is adjusted by controlling the stage assembly 210 in the various planes (or also by also controlling the pressure in an alternative embodiments) until all the gaps measured G2 are about the same. This results in the surface of the substrate 320 being controlled to be in parallel with the surface of the mold 300. Alternatively, the gap G2 can be measured using microscopes and alignment marks 311, 321 on the mold 300 and substrate 320. In addition, by observing the interference pattern between the mold 300 and the substrate 320, the surface of the substrate 320 can be adjusted to be in parallel with the surface of the mold 300.

Measuring the gap G2 between the mold 300 and the substrate 320 accurately can be advantageous for controlling the contact between substrate 320 and mold 300 during imprint. To improve the measurement accuracy, different approaches can be used and still be within the scope of the present disclosure. Referring to FIG. 20, a mold 300 with center pedestal 313 may be used for the measurement. The pedestal 313 can have a pre-defined known height between 0.1-100 μm. Gap sensor 311, 321 can be used to measure the distance Gap G1 and Gap G2 between the mold 300 and substrate 320. By comparing the difference between Gap G1 and Gap G2 with the real pedestal height, the sensor 311, 321 can be accurately calibrated linearly. In addition, as sensor signals have to pass through the window 110, coating the window 110 using multiple layer thin films will reduce the reflection of the optical signals, therefore increase the signal to noise ratio of the sensors 311, 321. Gap G1 between the mold 300 and substrate 320 that can be measured has a range of about 100 nm to about 3 mm.

Referring to FIG. 3b, next step of the imprint process is to pump chamber volume 150 and mold mini-chamber 160 to remove air or any gas or other substance contained therein. This pumping step facilitates to reduce trapped air defects of imprinted patterns. Alternatively, an extra pneumatic line is equipped with the machine which allows special gas with fast diffusion such as Helium to be used to facilitate the removal of air in the chamber 150.

Aligning the substrate 320 with the mold 300 can be finished before the pumping or in the pumping. Normally, aligning the substrate 320 and the mold 300 is accomplished by positioning an align marker on the substrate 320 overlapping with a matching align marker on the mold 300 under microscopes 405, 406. To prevent possible shift of the substrate 320 on chuck 230 during the pumping, both the substrate 320 and mold 300 can be mechanically clamped in positions. Alternatively, different clamping methods may be used other than mechanical. For example, electrostatic chucks may be used to “clamp” the mold 300 and/or the substrate 320 to their holding chucks using electrostatic forces. A combination of electrostatic force and mechanical force may also be used to hold the mold 300 and/or the substrate 320 uniformly to their respective holder. By using the vertical microscope 405 and alignment marks on the substrate 320 and mold 300, the substrate 320 is first moved to coarsely align with the mold 300. This will remove the small error generated during loading and machine assembling, and make sure the fine alignment marks on the mold 300 and substrate 320 are located in the same field of view, therefore no further searching of alignment marks necessary, significantly improving the alignment speed and reliability, which are required for manufacturing. Referring to FIG. 19, the 3 titled microscopes 406 can then read mis-alignments at a plurality of different locations by using the fine alignment marks. The finer X, Y, and rotation error can be corrected by substrate stages 210.

The substrate 320 can be moved up to contact with the mold 300 under a controlled movement or push by the stage assembly 210. The substrate 320 surface to be patterned can be adjusted in parallel with mold pattern surface by the leveling mechanism in the system before the final contact and before pressing or imprinting. Optical and force sensors 507 can be used to locate the exact contacting point and contact force. To accomplish the contact step, substrate 320 can moved up slowly until there is a slight controllable contact force between the mold 300 and substrate 320 detected. Then the mold 300 can be released from the mold holder 200 such as by removing the mechanical clamp and/or holding vacuum such as from the inner mini-chamber 160. Under the gravity force, the mold 300 will move down to contact the substrate 320 with the two facing surfaces of the mold 300 and the substrate 320 in parallel. In such embodiments, this initial contact under minimal force (such as only gravity force of the mold 300 onto the substrate 320) can prevent relative movement between the mold 300 and the substrate 320, therefore maintaining the relative position between them.

In an alternative embodiment for forming the contact is realized by deforming the mold 300. Referring to FIG. 13a, 13b, step 2011, the substrate 320 is positioned to have a predetermined gap G1 between the mold 300 and the substrate 320. Then, the mold 300 is deformed to press against the substrate 320 by implementing a differential vacuum or pressure between mold mini-chamber 160 and chamber volume 150. The center of the mold 300, which has the most significant deformation, contacts with the substrate first. As the differential vacuum or pressure increases and/or over time, the contact between the mold 300 and the substrate 320 expands outward from the center of the deformed mold 300 towards the periphery of the mold 300. At a specific differential vacuum or pressure, full area of the substrate 320 contacts with the deformed mold 300. The differential vacuum and pressure necessary to establish the full area contact is determined by factors such as dimensions, peripheral clamping, body thickness and physical characteristics thereof, temperature, pressure, and material of the mold 300, gap prior to deforming mold, and, overall dimensions of the substrate. During establishing the full area contact, moldable material 350 under pressure of the contact redistributes from the center outwards to form an intermediate layer of continuous film. Next, vacuum pumping from the back side of the substrate 320 through the vacuum grooves is removed to make the substrate 320 releasable from the chuck 230. At last, the mold 300 is restored to its original shape by removing the differential vacuum or pressure while retaining the contact with the substrate 320. The intermediate moldable material provides adhesion necessary to retain the contact between the mold 300 and the substrate 320.

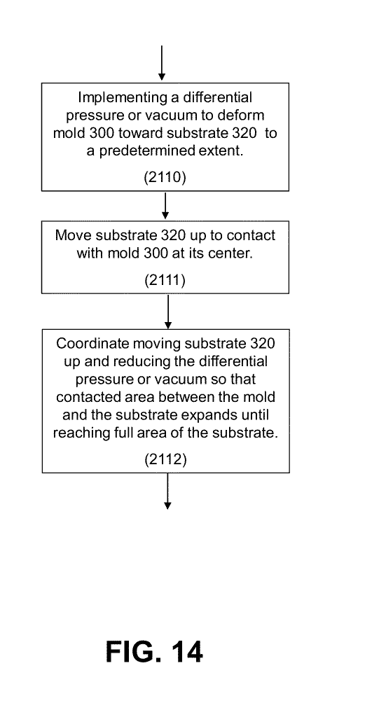

Referring to FIG. 14, another alternative embodiment for accomplishing the contact step of FIG. 2b is to deform the mold 300 at a predetermined extent and move the substrate 320 up against the deformation. At first, referring to step 2110, the mold 300 is deformed toward the substrate 320 to a predetermined extent by implementing a differential pressure or vacuum between mold min-chamber 160 and chamber volume 150. The optimal condition for the predetermined extent of deformation is affected by the thickness of the substrate 320, and variations thereof, and variations of surface parallelism between mold 300 and substrate 320. The predetermined extent of deformation prefers to have the center of the mold 300 deformed downward by 0.05-3 millimeters. Then, referring to step 2111, substrate 300 is moved up to contact with deformed mold 300 at its center where maximum deformation occurs. After that, referring to step 2112, moving substrate 300 up is coordinated with reducing the differential pressure or vacuum so that contacted area between the mold 300 and the substrate 320 expands accordingly until reaching full area of the substrate 320. The step can be realized by repeating small changes of moving the substrate 320 and reducing the differential pressure or vacuum. It is desired that the mold 300 is restored to its original shape when the full area contact is reached. The process of making the contact does not depend on adhesion provided by intermediate moldable material 350 and is able to squeeze any residual air out of interim region between the mold 300 and the substrate 320. Thus, it may be conducted at atmosphere without causing serious trapped air defects for imprinted patterns.

In several embodiments, when the contact step of FIG. 3b is accomplished, the moldable material 350 has been pressed lightly and redistributed to fill space between the mold 300 and the substrate 320. For case of using very low viscosity moldable material, the press caused by the contact may be sufficient to imprint patterns of the mold 300 into the moldable material 350. In order to guarantee quality of patterns imprinted, it may need to apply higher pressure press on the mold 300 and the substrate 320 than the contact.

Referring to FIG. 3c, higher pressure press is applied on the mold 300 and the substrate 320 by filling mold mini-chamber 160 and chamber volume 150 with high pressure gas. Air Cushion Press (ACP) is fully realized during this step for imprinting. Details of Air Cushion Press are described by Stephen Y. Chou in U.S. Pat. No. 6,482,742 under a title of “Fluid Pressure Imprint Lithography”, which is herein incorporated by reference. The ACP realized herein does not use a film or O-ring to seal edge in order for ACP to work properly. Instead, it depends on the prior contact and the intermediate moldable material to seal the contacting periphery of the mold 300 and the substrate 320. This improvement of eliminating film or O-ring is very significant for the apparatus to achieve higher throughput and reliability. Chuck 230 may be moved away from contacting the back side of the substrate 320 during this step so as not to degrade pressing uniformity of ACP. After reaching desired pressure for ACP, the moldable material 350 redistributes to completely fill every space between the mold 300 and the substrate 320, then, is consolidated to solid by a UV exposure through section 110, or section 111, or both. Finally, the high pressure gas for ACP is vented to atmosphere. So far, pattern formation of imprinting is completed. The substrate 320 is ready for being released from the mold 300.

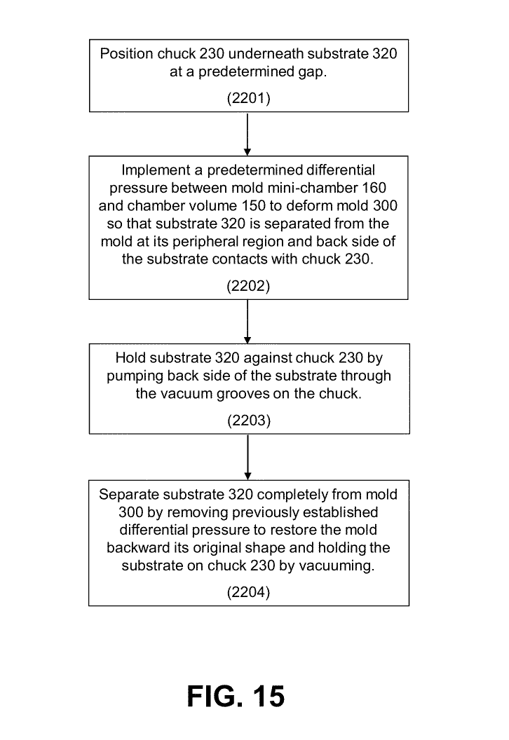

Referring to FIG. 3d, the substrate 320 is separated from the mold 300. The separation can be realized by combining mold deformation and stage movement. FIG. 15 illustrates a way to separate the substrate 320 from the mold 300. Referring to step 2201 of FIG. 15, the separation starts from positioning chuck 230 underneath substrate 320 at a predetermined gap. Then, referring to step 2202, a differential pressure between mold mini-chamber 160 and chamber volume 150 is introduced to deform the mold 300. As deformation is enlarged by increasing the differential pressure, substrate 320 loses contact from the mold 300 starting from periphery and expanding toward center. Meanwhile, substrate 320 is lowered down until it is supported by chuck 230. The differential pressure reaches a predetermined value so that back side of substrate 300 completely contacts with chuck 230. By now, a significant peripheral region of the substrate 320 is released from the mold 300 and central region of the substrate 320 is not yet. After that, referring to step 2203, the substrate 320 is held against chuck 230 by pumping back side of the substrate 320 through the vacuum grooves on the chuck surface. Finally, referring to step 2204, the established differential pressure is removed to restore the mold backward its original shape. Because the substrate 320 is vacuum held against the chuck 230, the remaining central area of the substrate 320 is separated from the mold 300. The substrate 320 stays on chuck 230 after the separation and the mold 300 is returned to its starting status.

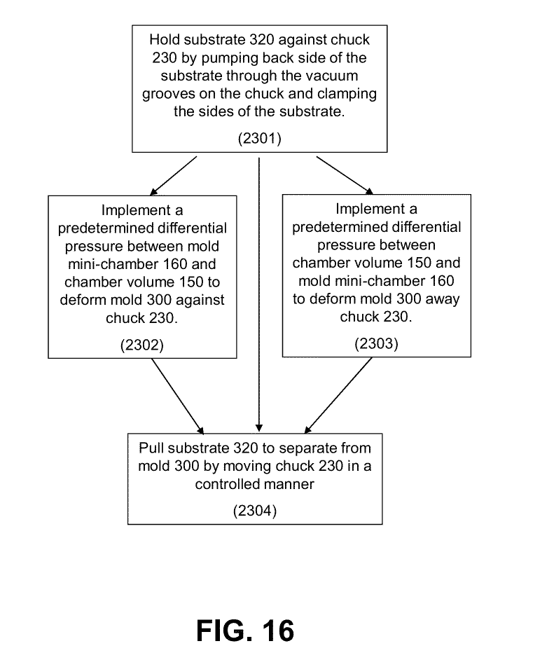

Alternative ways to separate the substrate 320 from the mold 300 are illustrated in FIG. 16. These ways share a common concept that use both vacuum and mechanic means to hold the mold 300 and the substrate 320, and pull the substrate 320 in certain way using the stage assembly to create the motion to separate. The mold 300 may be intentionally deformed to further facilitate the separation. Referring to step 2301 of FIG. 16, the separation starts from vacuum holding back side of substrate 320 against top surface of chuck 230 by pumping through the vacuum groves on the chuck 230. If chuck 230 is away from the substrate 320, the chuck 230 is positioned to contact back side of the substrate 320 by the stage assembly 210 prior to the vacuum holding. Referring to step 2304, one way to separate is to pull substrate 320 downward by moving the stage assembly 210 down. Because the substrate 320 is held against the vacuum grooves on the chuck 230 and the mold 300 is deformable, at beginning of the pull, the mold 300 is deformed so that periphery of the substrate 320 is separated first. As the downward pulling is progressing, the separated region of the substrate 320 propagates from the firstly separated periphery inner ward the center. At end of the downward pulling, the substrate 320 is completely separated from the mold 300.

To improve this separation process, referring to step 2302 prior to step 2304, a predetermined differential pressure is implemented between mold mini-chamber 160 and chamber volume 150 to deform the mold 300 against chuck 230. Present of the differential pressure makes the mold 300 more easily deformable when the substrate 320 is pulled downward. Thus, the separation is improved to be more easily and reliably. The differential pressure is predetermined so that the mold 300 is not under risk of rupture when the substrate 320 is separated and the chuck 230 is moved away. Referring to step 2303, it can also implement a reverse differential pressure between mold mini-chamber 160 and chamber volume 150 to deform the mold 300 away from chuck 230. In such way, the mold 300 is more easily deformed away from the substrate 320 to improve the separation when the substrate 320 is pulled downward. This reverse differential pressure is predetermined not to risk the mold 300 for any possible rupture when the substrate 320 is separated. For this case, a supporting surface could be specially designed on inner top wall of the chamber 140 to limit maximum reverse deformation of the mold 300.

After the substrate 320 is separated from the mold 300, any differential pressure implemented previously is removed to restore the mold 300 to its original shape. Alternatively, the separation motion of the substrate 320 can be much more complex than a simple downward pulling motion to best separate the substrate 320 from the mold 300, reducing the possible damage to nano-scale patterns and improving separation speed. The stage assembly 210 holding the substrate 320 in the system can be capable of 6 axis motion movements, therefore the substrate 320 can move with its motion and speed accurately controlled. The separation may include movements of multiple steps with the speed and direction of each movement be controlled. In one example, the substrate 320 moves in both tip and tilt motion, and at the same time moves down in Z: the combination movement can be controlled to peel the substrate 320 from the mold 300 diagonally. In another example, the separation include 2 step movements: first the substrate 320 moves down in Z while going through tilt motion, then it moves down in Z going through tip motion.

The mold 200 used for the apparatus may or may not need to be deformable under a reasonable differential pressure between its two sides. The mold 300 could be made of quartz, glass, polymer, semiconductor, metal or a mixture of some of the above materials, by ways of example and not limited thereto. One example of the mold 300 uses 8″ diameter quartz or glass wafer with a substrate thickness 0.2-1 mm; another example of the mold uses 12″ diameter quartz or glass wafer with a substrate thickness of about 0.2-2 mm; one more example of the mold uses 8″ diameter Ni substrate with a thickness of about 0.1-1 mm; yet one more example of the mold uses 200 mm diameter Si substrate with a thickness of about 0.1-2 mm; one more example of the mold uses 6″ by 6″ quartz substrate with a thickness of about 0.1-25 mm.

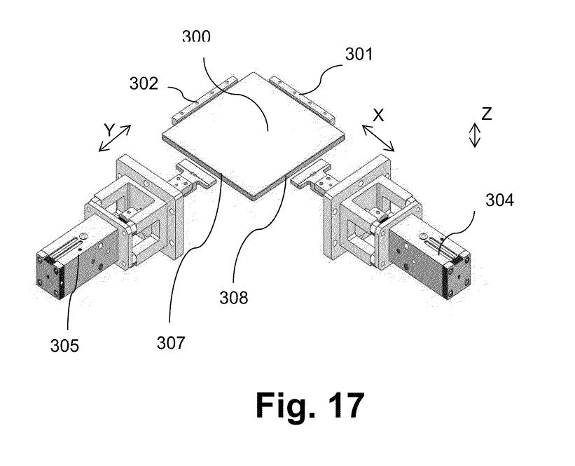

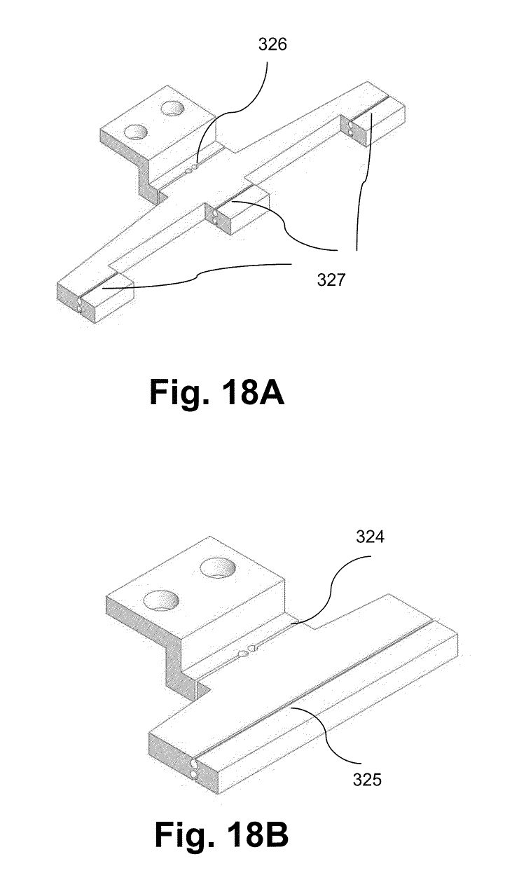

In many applications, the changing of the size of the mold 300 to correct the dimension variation during various processing steps can be critical. The magnification control apparatus in the system is shown in FIG. 17. Piezo driven mechanical clamps can be used to push the side surfaces 307 and 308 of the mold 300. The force applied by the two piezo drivers 304 and 305 will push the mold 300 against the two mechanical stops 302 and 301 on the other side. By controlling the force applied by the two piezo drivers 304, the deformation of the mold 300 along X and Y direction can be controlled. FIG. 18a shows a detailed structure of an example of such clamp heads while FIG. 18b shows an alternative design, by way of two examples. By using compliant flexure structures 324, 325, 326, and 327, the head of the clamp can be capable of compensating for minor rotation of mold 300 relative to the push piezos along X, Y and Z directions, therefore applying a uniform force on the mold 300. The distortion of the pattern can be minimized. Alternatively, different motion driving devices may be used to replace the piezos to apply pushing force on the mold 300. For example, air cylinders with pressure accurately controlled and force calibrated may be used. In another example, linear motion stages may also be used to drive the compliant flexure structures.

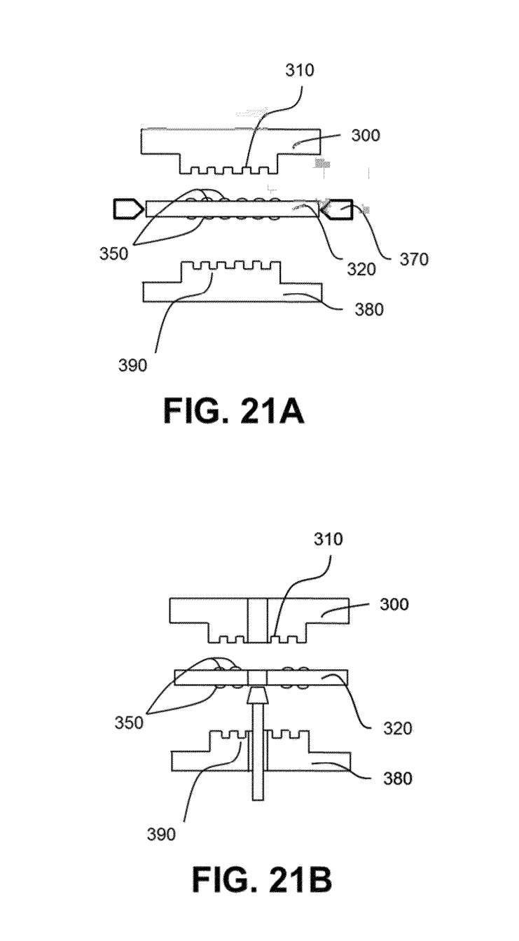

In other embodiments, the same disclosed system can be easily modified to pattern the front side and back side of substrates 320 simultaneously. Referring to FIG. 21A, a first mold 300 is loaded to the mold holder 200 using the same mold loading procedure described in step 1110, then a second mold 380 is loaded into the substrate holder inside chamber 140 with the patterning surface 390 up using the same substrate loading procedure described in step 1111, finally the substrate 320 to be patterned is loaded in between, with a clamp 370 holding it. The clamp 370 may be mounted on multi-axis motion stage (not shown). The stages and the clamp 370 can then move and the substrate 320 and at least one of the molds 300, 380 to make the contact with the other mold 300, 380 for patterning both surfaces of the substrate 320. Separation can be started between the first mold 300 to the substrate 320, then between the substrate 320 to the second mold 380. One may unload the substrate 320 from the clamp 370. One may also use the same substrate 320 unloading procedure (step 1113) to unload the second mold 380 and same mold unloading procedure (step 1114) to unload the first mold 300. FIG. 21B demonstrates an alternative design where the substrate 320 can also held by a separate stage mounted in the center. The second mold 380 with its patterning surface 390 up will need to have an opening in the center for the stage to move through.

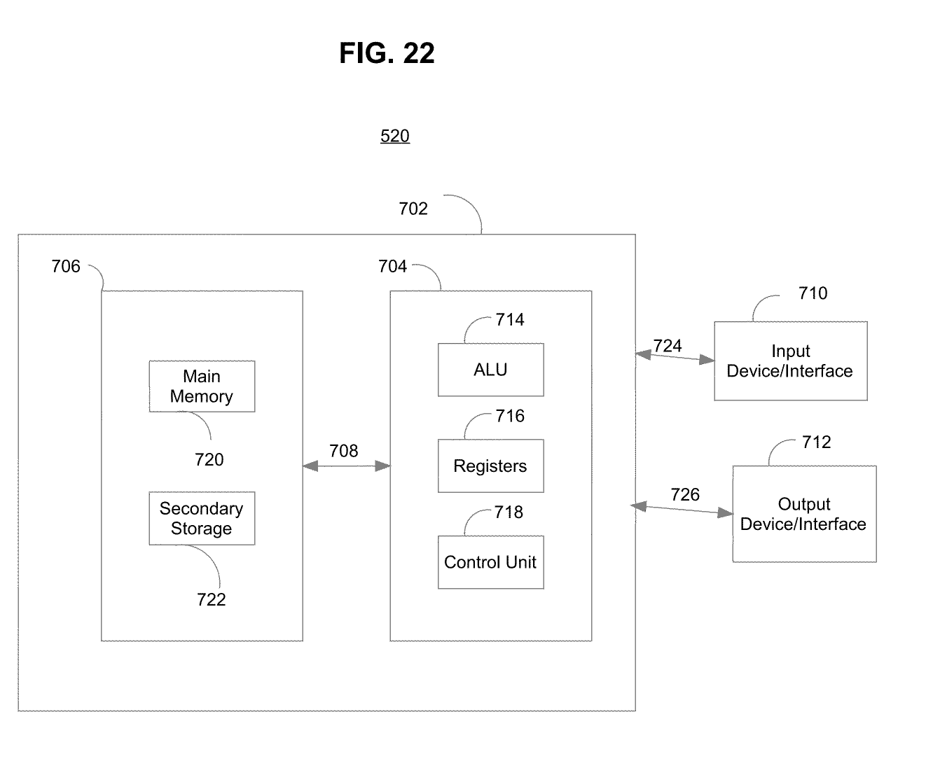

Referring to FIG. 22, an operating environment for an illustrated embodiment of the controller 520 having a computer 702 that comprises at least one high speed processing unit (CPU) 704, in conjunction with a memory system 706 interconnected with at least one bus structure 708, an input device 710, and an output device 712.

The memory system 706 generally includes high-speed main memory 520 in the form of a medium such as random access memory (RAM) and read only memory (ROM) semiconductor devices, and secondary storage 722 in the form of long term storage mediums such as floppy disks, hard disks, tape, CD-ROM, flash memory, SSD, etc. and other devices that store data using electrical, magnetic, optical or other recording media. The main memory 720 also can include video display memory for displaying images through a display device. Those skilled in the art will recognize that the memory system 706 can comprise a variety of alternative components having a variety of storage capacities.

The input device 710 and output device 712 are also familiar. The input device 710 can comprise a keyboard, a mouse, a physical transducer (e.g. a microphone), etc. and is interconnected to the computer 702 via an input interface 724. The output device 712 can comprise a display, a printer, and a transducer (e.g. a speaker), and be interconnected to the computer 702 via an output interface 726. Some devices, such as a network adapter or a modem, can be used as input and/or output devices.

As is familiar to those skilled in the art, the controller system 520 further includes an operating system and at least one application program. The operating system is the set of software which controls the computer system's operation and the allocation of resources. The application program is the set of software that performs a task desired by the user, using computer resources made available through the operating system. Both are resident in the illustrated memory system 706.

In accordance with the practices of persons skilled in the art of computer programming, the present invention is described below with reference to symbolic representations of operations that are performed by the controller 520. Such operations are sometimes referred to as being cuter-executed. It will be appreciated that the operations which are symbolically represented include the manipulation by the CPU 704 of electrical signals representing data bits and the maintenance of data bits at memory locations in the memory system 506, as well as other processing of signals. The memory locations where data bits are maintained are physical locations that have particular electrical, magnetic, or optical properties corresponding to the data bits. The invention can be implemented in a program or programs, comprising a series of instructions stored on a computer-readable medium. The computer-readable medium can be any of the devices, or a combination of the devices, described above in connection with the memory system 706.

The improvements as disclosed herein are emphasized again. The exemplary apparatus embodiments described in this disclosure can provide a full cycle of imprinting inside the chamber through a process essentially involving deforming the mold and positioning the substrate by the stage assembly. The speed to finish each step of the process can be primarily decided by stage response and how fast to deform the mold. Using state-of-art stage technology, stage response can be very fast and capable of responding to requests of each step in seconds. Furthermore, the disclosed chamber uses vacuum to eliminate possibility of trapping air between the mold and the substrate. The intrinsic Air Cushion Press (ACP) of the process provides very uniform imprinting force which can be crucial to achieve the pattern fidelity required by manufacturing. Eliminating needs of using a film or o-ring to seal edge for proper ACP can also provide a significant improvement over the prior art that provides for faster imprinting cycle and longer operating reliability times.

It is to be understood that the above described embodiments are illustrative of only a few of the many embodiments that can represent applications of the invention. Numerous and varied other arrangements can be made by those skilled in the art without departing from the spirit and scope of the invention.

When describing elements or features and/or embodiments thereof, the articles “a”, “an”, “the”, and “said” are intended to mean that there are one or more of the elements or features. The terms “comprising”, “including”, and “having” are intended to be inclusive and mean that there may be additional elements or features beyond those specifically described.

Those skilled in the art will recognize that various changes can be made to the exemplary embodiments and implementations described above without departing from the scope of the disclosure. Accordingly, all matter contained in the above description or shown in the accompanying drawings should be interpreted as illustrative and not in a limiting sense.

It is further to be understood that the processes or steps described herein are not to be construed as necessarily requiring their performance in the particular order discussed or illustrated. It is also to be understood that additional or alternative processes or steps may be employed.

What is claimed is:

1. A method to pattern nano structures on a substrate from a mold comprising the steps of:
having a mold having a mold surface with nanostructures;
having a substrate having a surface;
depositing a deformable material on the surface of the substrate;
positioning in a chamber the substrate with the deposited deformable material in a position facing the mold surface of the mold having the nanostructures and having a gap there between;
applying a vacuum in the chamber including the gap defined between the positioned substrate and mold;
forming a contact between the surface of the substrate and the mold surface of the mold;
holding the contact for a predetermined period of time; and
separating the substrate and the mold with the deformable material remaining on the substrate and being patterned with nanostructures corresponding to the nanostructures of the mold surface.

2. The method of claim 1 wherein holding the contact includes:
applying at a predetermined pressure one or more gases in an area of the chamber that is proximate to the mold and the substrate; and
removing the applied gases to return the pressure to atmospheric pressure.

3. The method of claim 1 wherein forming a contact includes
determining an initial distance of the gap between the mold surface and the substrate surface;
adjusting at least one of the substrate and the mold to establish the predetermined value of the distance of the gap; and
after the step forming the contact, pressing the mold and the substrate towards to each other using a predetermined and/or controlled pressure.

4. The method of claim 3 wherein the pressing includes fluid pressure applied at a pressure of between about −14.6 psi and about 500 psi.

5. The method of claim 4 wherein the fluid pressure is supplied by a non-reactive gas from a group of gases selected from the group consisting of nitrogen, air, argon, and helium.

6. The method of claim 1 wherein the forming contact is controlled to deform a center portion of the mold and the substrate more than other portions thereof so that the contact between the mold surface and the substrate surface if first made in a center of the mold and in a center of the substrate, and wherein the forming continues until contact continues outwards from the initial center contact to throughout the area of the mold surface.

7. The method of claim 1 wherein forming contact includes
securing at least one of the substrate and the mold;
determining an initial distance of the gap between the mold surface and the substrate surface;
adjusting at least one of the substrate and the mold to establish the predetermined value of the distance of the gap;
after the predetermined gap distance is adjusted, applying a controllable force to move the mold and/or substrate into contact; and
after contact is formed by the application of the controllable force, releasing the secured at least one of substrate and the mold so at least one of the contacting mold surface and substrate surface continue to contact in an unrestricted manner.

8. The method of claim 7 wherein applying the controllable force includes applying upward uniform fluid pressure on the substrate so the opposing sides of the substrate and the mold freely contact each other.

9. The method of claim 1 wherein forming contact includes:
determining an initial distance of the gap between the mold surface and the substrate surface;
adjusting at least one of the substrate and the mold to establish the predetermined value of the distance of the gap;
deforming the mold to form the contact between the substrate surface and the mold surface; and
restoring the mold to its original shape while the substrate retains the contact with the mold.

10. The method of claim 9 wherein said deforming the mold includes controlling a differential pressure between two sides of the mold for said deforming.

11. The method of claim 1 wherein forming contact includes moving at least one of the substrate and the mold towards the other until the contact occurs.

12. The method of claim 1 wherein separating includes
retaining at least a portion of a non-contact side of the mold that is opposing the mold surface;
retaining at least a portion of a non-contact side of the substrate that is opposing the surface having the deformable material deposited thereon;
moving the substrate away from the mold in a series of controlled motions until the substrate is released from the mold, said controlled motion being controlled for movement in one or more of 6 axis x, y, z, theta, tip, tilt and including one or more control factors selected from the group consisting of distance, motion, force speed, acceleration, deceleration, and time.

13. The method of claim 1 wherein separating includes
retaining at least a portion of a non-contact side of the mold that is opposing the mold surface;
retaining at least a portion of a non-contact side of the substrate that is opposing the surface having the deformable material deposited thereon;
deforming the mold until initially a peripheral region of the substrate is first released from the mold, said deforming being effected by a differential pressure between two opposing sides of the mold; and
restoring the mold to its original shape until the substrate is released from the mold.

14. The method of claim 1 wherein the applying of vacuum includes removing the gas molecules from the spacing between the mold and the substrate to a pressure of between about 0.1 to about 25 torr.

15. A system for patterning a substrate comprising:
a mold holding fixture for holding a mold having a mold surface with nano structures;
a substrate holding fixture for holding a substrate having a molding surface;
a stage assembly having a plurality of independent axis movements;
a contact force sensor positioned for sensing a contact force between the mold surface and the molding surface;
a chamber housing defining a chamber having at least a mold held by the mold holding fixture and the substrate held by the substrate holding fixture positionable therein, the chamber housing configured enabling the applying of a pressure inside the chamber that is higher and/or lower than atmospheric pressure;
a pressure regulator and a manifold each being fluidly coupled to the chamber for changing the pressure inside the chamber;
a gas reservoir of high pressure, a regulator and piping to allow the high pressure gas;
a door on the chamber housing for selectively allowing the substrate and the mold to pass there through; and
means to divide the chamber into two fluidly separate sub-chambers, each sub-chamber being configured for a separate controlled sub-chamber environment including a separate pressure and/or vacuum, a separate gas content, and a separate gas flow rate into and out thereof.

16. The system of claim 15 wherein the mold holding fixture is configured for holding only a periphery of the mold, said mold holding fixture being hollow to expose a central area of the mold for accessing from the side of the molding surface and the opposing side, the mold holding fixture being attached to inner surface of the chamber and having substantially flat surfaces for uniformly holding the mold with substantially distributed equalized pressure for minimizing deformation of the held mold.

17. The system of claim 15 wherein the mold holding fixture is configured for holding a periphery of the mold and having substantially flat surfaces for uniformly holding the mold with substantially distributed equalized pressure for minimizing deformation of the held mold.

18. The system of claim 15, further comprising a robot having end effectors and controlled by a computer with computer executable instructions, each configured for placement of a substrate in a first position inside the chamber, and placement of a mold in a second position inside the chamber cavity.

19. The system of claim 18 wherein the robot is configured for placement of a plurality of molds and plurality of substrate, each of which has a different size and/or composed of a different material, and wherein the robot is configured for changing the orientation of the mold or the substrate by flipping it 180 degrees.

20. The system of claim 18 wherein the robot includes at least one arm coupled to a driving means and wherein the at least one arm includes two end effectors for handling the mold and the substrate.

21. The system of claim 18, further comprising at least one loader positioned proximate to the robot and the chamber housing, each loader configured for housing a plurality of cassettes, each cassette holding one or more molds or substrates, and wherein the end effectors are configured for removing a mold and/or a substrate from one of the cassettes for placement within the chamber and return thereto.

22. The system of claim 15 wherein the chamber housing includes one or more windows to the chamber configured for allowing light of one or more wavelengths to pass through the window while maintaining the applied pressure inside the chamber.

23. The system of claims 22 wherein at least one of the chamber windows is coated with multiple layer thin films for reducing light reflections on the window surfaces.

24. The system of claim 15, further comprising
at least one gap measurement device for determining a gap distance between the mold surface of the mold and the molding surface of the substrate while each is in the chamber; and
a gap distance control means for adjusting a position of at least one of the mold and the substrate to obtain a predetermined distance.

25. The system of claim 24 wherein the at least one gap measurement device includes at least one of an optical detection system configured for determining a spatial relationship between the mold and the substrate; or
at least one sensor selected from the group consisting of a laser sensors, and optical sensors, an optical microscopes, and a radiofrequency transceiver sensor.

26. The system of claim 24 wherein the gap measurement device further includes one or more optical microscopes and wherein each of the mold and the substrate include alignment marks, the optical microscopes configured and positioned for observing each of the mold and the substrate alignment marks when the mold and the substrate are positioned within the chamber under an applied pressure.

27. The system of claim 15, further comprising at least one of
means to deform the mold transversely toward or away from the substrate while each are within the chamber; and
means to deform the substrate towards or away from the mold using multiple motions capable of six degree of freedom while each are within the chamber.

28. The system of claim 15, further comprising one or more UV lamps positioned either outside or inside of the chamber for exposing UV radiation onto the substrate.

29. The system of claim 15 wherein the mold holding fixture includes one or more mechanical stops; further comprising:
one or more mechanical clamps coupled to the mold; and
piezo drivers coupled to mechanical clamps, the piezo drivers and the mechanical clamps configure to apply a pressure against a mold held by the clamps and push the mold against mechanical stops and controllably deforming the mold along at least one of the X and Y directions.

30. The system of claim 15 wherein the mold is made of a material selected from the group consisting of a quartz, a glass, a silicon, a Ni, a plastic, and a semiconductor, and wherein the mold has a mold thickness of between about 0.1 mm to about 25 mm.

31. The system of claim 15 wherein the mold holding fixture and the substrate holding fixture are each configured within the chamber for holding the mold and substrate respectively in any orientation therein, and wherein each are configured for holding using a force selected from the group consisting of a vacuum, a mechanical force, and an electrostatic force.

32. The system of claim 15 wherein two molds and one substrate may be loaded inside chamber, said substrate is placed between said molds, and the deformable materials on both front and back surfaces of the substrate may be pressed by the said two molds.

33. A method for aligning a mold and a substrate within a chamber for use in nanoimprinting comprising:
providing a mold having a mold surface;
forming a pedestal of predetermined height in a center of the mold;
placing nanostructures on a top surface of the formed pedestal;
placing alignment marks and gap sensing marks on both the top surface of the pedestal and the lower surface of the mold surface not containing the pedestal;
providing a substrate having a molding surface;
depositing a deformable material on the surface of the substrate;
placing gap sensing marks and alignment marks on the substrate;
calibrating a gap measurement device having gap sensors using the predetermined pedestal height;
detecting the gap sensing marks of the mold and the substrate to determine a gap distance between the mold surface and the molding surface;
detecting the alignment marks of the mold and the substrate to determine an alignment of the molding surface with the mold surface; and
using the determined gap distance and the determined alignment to control the position of at least one of the mold and the substrate within the chamber for leveling the mold surface with the molding surface of the substrate and controlling the gap there between.

34. The method of claim 33 wherein the height of the pedestal has a range of about 0.1 to about 100 microns.

35. The method of claim 33 wherein detecting the alignment marks including detection using one or more optical microscopes.

36. The method of claim 33 wherein detecting the gap between the mold and substrate is determined using one or more optical microscopes or optical sensors.

37. The method of claim 33 wherein the determination of the gas is calibrated by measuring the gap between the mold pedestal surface and the substrate surface and the gap between the lower mold substrate and the substrate, and comparing the difference of the two measured gaps to the predetermined pedestal height to calibrate the gap readings linearly.

38. The method of claim 33 monitoring the gap sensing marks of the mold and the substrate to determine a gap distance between the mold surface and the molding surface and wherein the microscopes and optical sensors use a working wavelength from visible to IR (400 nm-2000 nm).

39. The method of claim 33 wherein the gap between the mold and substrate has a range of about 100 nm to about 3 mm.
